(19) United States
(12) Patent Application Publication
(10) Pub. No.: US 2026/0190095 A1
(43) Pub. Date: Jul. 2, 2026

(54) CONTROL DEVICE, WIRELESS COMMUNICATION METHOD, WIRELESS COMMUNICATION SYSTEM AND CONTROL PROGRAM

(71) Applicant: NTT, Inc., Tokyo (JP)

(72) Inventors: Shoko SHINOHARA, Musashino-shi, Tokyo (JP); Yusuke ASAI, Musashino-shi, Tokyo (JP); Yoshitaka SHIMIZU, Musashino-shi, Tokyo (JP); Junichi IWATANI, Musashino-shi, Tokyo (JP); Tomoyuki YAMADA, Musashino-shi, Tokyo (JP); Yasushi TAKATORI, Musashino-shi, Tokyo (JP)

(73) Assignee: NTT, Inc., Tokyo (JP)

(21) Appl. No.: 18/855,344

(22) PCT Filed: Apr. 18, 2022
(86) PCT No.: PCT/JP2022/018065

§ 371 Date: Oct. 9, 2024

(51) Int. Cl. H04W 72/0453; H04W 72/02; H04W 72/542

(52) U.S. Cl. CPC H04W 72/0453; H04W 72/02; H04W 72/542

(57) ABSTRACT

A control device according to an embodiment performs control to: calculate a transmission capacity of each channel as an evaluation value and calculate an evaluation value total of each combination of one or more channels whose frequency bands do not overlap each other; select a combination of a predetermined number of channels in which the calculated evaluation value total is a maximum within a predetermined range; calculate a weighting factor indicating a proportion of a use period of each channel included in the selected combination, based on a transmission rate or a transmittable data amount of each channel; calculate a switching time for switching a channel for each channel included in the selected combination, based on the calculated weighting factor; and switch a channel included in the selected combination and transmit traffic, based on each calculated switching time.

### TECHNICAL FIELD

The present invention relates to a control device, a wireless communication method, a wireless communication system, and a control program.

### BACKGROUND ART

In some wireless communication systems using the 920 MHz band in Japan, a total sum of transmission times per unit time is limited for each channel. For example, the sum of the transmission times of the wireless communication terminals is limited to 360 seconds per hour (duty ratio 10%) or less.

In recent years, since Internet of Things (IoT) terminals have become widespread and applications thereof have been diversified, there are usage examples in which only short-time communication is not sufficient as in the related art (such as transmission of surveillance camera video in a wide area).

In a case where there is a limitation (duty limitation) on the sum of the transmission times as described above, the amount of transmittable data is limited separately from a potential of a wireless communication terminal, and thus a sufficient amount of transmission cannot be secured in some cases.

However, the limitation of the total sum of the transmission times is a limitation per channel, and transmission of up to 720 seconds can be performed per wireless communication terminal by utilizing a plurality of channels.

In this case, a condition for increasing the total sum of transmission times (duty ratio) used by one wireless transmission device is as follows.
Using a plurality of non-overlapping channels (two or more channels)
Channels are used by being “switched” (simultaneous use is prohibited in principle)
Use of each channel requires a transmission time, carrier sense, and pause time for each channel.

### CITATION LIST

### Non Patent Literature

Non Patent Literature 1: IEEE Standard for Information Technology-Telecommunications and Information Exchange between Systems Local and Metropolitan Area Networks-Specific Requirements Part 11: Wireless LAN Medium Access Control (MAC) and Physical Layer (PHY) Specifications Amendment 1: Enhancements for High-Efficiency WLAN, IEEE Computer Society, Developed by the LAN/MAN Standards Committee, IEEE Std 802.11ax™-2021 (Amendment to IEEE Std 802.11-2020), Approved 9 Feb. 2021, IEEE SA Standards Board

### SUMMARY OF INVENTION

### Technical Problem

However, channels that can be used for wireless communication are limited, and it cannot be said that any channel can be switched. In addition, unlike the conventional channel selection method, in a case where a plurality of channels is selected, there is a condition that occupied bands do not overlap each other.

Furthermore, in a case where switching to a channel having a different bandwidth is performed, the amount of data that can be transmitted is different before and after the switching, and it is also conceivable that a communication quality changes and a quality of experience of a user deteriorates.

In addition, in a case where a plurality of channels is switched and used, not only are two wireless communication modules mounted in one housing in a wireless communication terminal, but also time control or status control is required.

The present invention has been made in view of the above-described problems, and an object of the present invention is to provide a control device, a wireless communication method, a wireless communication system, and a control program capable of maximizing a transmission capacity within a predetermined range even when a sum of transmission times for transmitting traffic per unit time is limited for each channel.

### Solution to Problem

A control device according to an embodiment of the present invention controls a wireless communication system in which a sum of transmission times for transmitting traffic per unit time is limited for each channel and which performs wireless communication using at least one of a plurality of channels, the control device including: an evaluation value total calculation unit that calculates a transmission capacity of each channel as an evaluation value and calculates an evaluation value total of each combination of one or more channels whose frequency bands do not overlap each other; a selection unit that selects a combination of a predetermined number of channels in which the evaluation value total calculated by the evaluation value total calculation unit is a maximum within a predetermined range; a weighting factor calculation unit that calculates a weighting factor indicating a proportion of a use period of each channel included in the combination selected by the selection unit, based on a transmission rate or a transmittable data amount of each channel; a switching time calculation unit that calculates a switching time for switching a channel for each channel included in the combination selected by the selection unit, based on the weighting factor calculated by the weighting factor calculation unit; and a switching control unit that performs control to switch a channel included in the combination selected by the selection unit and transmit traffic, based on each switching time calculated by the switching time calculation unit.

In addition, in a wireless communication method according to an embodiment of the present invention, a sum of transmission times for transmitting traffic per unit time is limited for each channel and wireless communication is performed using at least one of a plurality of channels, the wireless communication method including: an evaluation value total calculation step of calculating a transmission capacity of each channel as an evaluation value and calculating an evaluation value total of each combination of one or more channels whose frequency bands do not overlap each other; a selection step of selecting a combination of a predetermined number of channels in which the calculated evaluation value total is a maximum within a predetermined range; a weighting factor calculation step of calculating a weighting factor indicating a proportion of a use period of each channel included in the selected combination, based on a transmission rate or a transmittable data amount of each channel; a switching time calculation step of calculating a switching time for switching a channel for each channel included in the selected combination, based on the calculated weighting factor; and a switching control step of performing control to switch a channel included in the selected combination and transmit traffic, based on each calculated switching time.

In addition, in a wireless communication system according to an embodiment of the present invention, a sum of transmission times for transmitting traffic per unit time is limited for each channel and wireless communication is performed using at least one of a plurality of channels, the wireless communication system including: an evaluation value total calculation unit that calculates a transmission capacity of each channel as an evaluation value and calculates an evaluation value total of each combination of one or more channels whose frequency bands do not overlap each other; a selection unit that selects a combination of a predetermined number of channels in which the evaluation value total calculated by the evaluation value total calculation unit is a maximum within a predetermined range; a weighting factor calculation unit that calculates a weighting factor indicating a proportion of a use period of each channel included in the combination selected by the selection unit, based on a transmission rate or a transmittable data amount of each channel; a switching time calculation unit that calculates a switching time for switching a channel for each channel included in the combination selected by the selection unit, based on the weighting factor calculated by the weighting factor calculation unit; and a switching control unit that performs control to switch a channel included in the combination selected by the selection unit and transmit traffic, based on each switching time calculated by the switching time calculation unit.

### Advantageous Effects of Invention

According to the present invention, even when a sum of the transmission times for transmitting traffic per unit time is limited for each channel, a transmission capacity can be maximized within a predetermined range.

### BRIEF DESCRIPTION OF DRAWINGS

FIG. 1 is a diagram illustrating a configuration example of a wireless communication system according to an embodiment.

FIG. 2 is a diagram illustrating a configuration example of an access point.

FIG. 3 is a functional block diagram illustrating functions of a control device.

FIG. 4 is a diagram illustrating parameters used for an operation example of a wireless communication system.

FIG. 5 is a flowchart illustrating an operation example of a wireless communication system according to an embodiment.

FIG. 6 is a diagram illustrating channels that can be used by a wireless communication system.

FIG. 7 is a flowchart illustrating processing executed by a control device for control to switch a plurality of channels.

FIG. 8 is a diagram illustrating parameters regarding weighting factors w1 and w2 in a case where a control device performs control to switch two channels.

FIG. 9 is a diagram illustrating a specific operation example of a wireless communication system according to an embodiment.

FIG. 10 is a diagram illustrating a hardware configuration example of a control device according to an embodiment.

### DESCRIPTION OF EMBODIMENTS

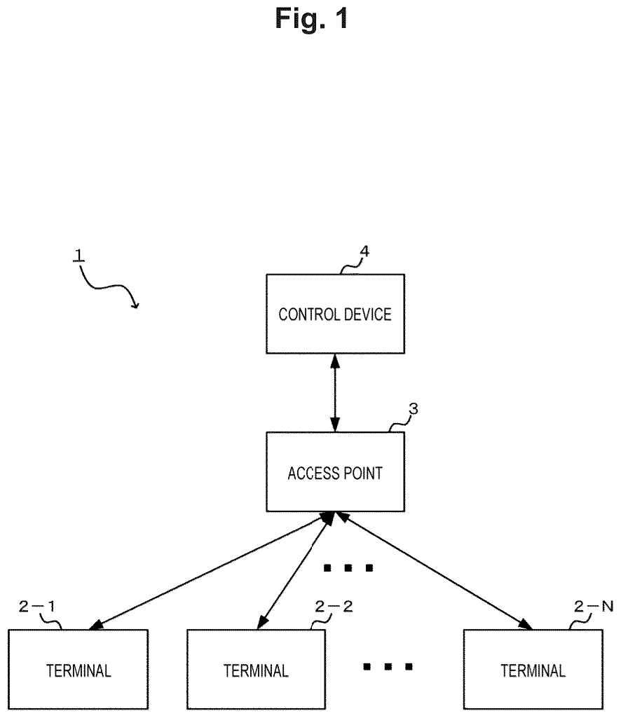

Hereinafter, a wireless communication system according to an embodiment will be described with reference to the drawings. FIG. 1 is a diagram illustrating a configuration example of a wireless communication system 1 according to an embodiment. As illustrated in FIG. 1, a wireless communication system 1 according to an embodiment is configured such that, for example, N terminals (wireless communication terminals: STAs) 2-1 to 2-N perform wireless communication via an access point (AP) 3. In addition, the access point 3 performs wireless communication according to control of a control device 4.

Note that, the wireless communication system 1 is configured such that a sum of transmission times for transmitting traffic per unit time is limited for each channel and, for example, each of the terminals 2-1 to 2-N and the access point 3 perform wireless communication using at least one of a plurality of channels, by the control of the control device 4.

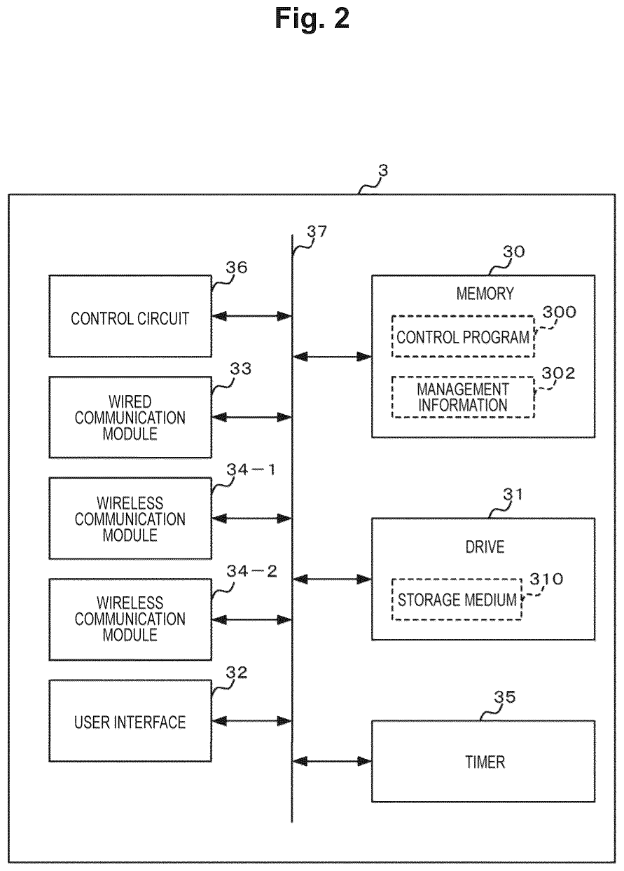

FIG. 2 is a diagram illustrating a configuration example of the access point 3. As illustrated in FIG. 2, in the access point 3, for example, a memory 30, a drive 31, a user interface 32, a wired communication module 33, wireless communication modules 34-1 and 34-2, a timer 35, and a control circuit 36 are connected via a bus 37.

The memory 30 is a storage device that stores, for example, a control program 300, a management information 302, and the like. The drive 31 performs reading or writing of data from or in the storage medium 310. The user interface 32 is an input/output device including, for example, a keyboard, a display, and the like.

The wired communication module 33 is a module that performs wired communication with other devices. The wireless communication modules 34-1 and 34-2 are modules that perform wireless communication with other devices. Note that the number of wireless communication modules included in the access point 3 is not limited to two.

The timer 35 measures a time in a case where the access point 3 performs control. The control circuit 36 controls each unit constituting the access point 3. For example, the control circuit 36 performs control using the time measured by the timer 35.

Note that each of the terminals 2-1 to 2-N and the control device 4 may be configured similarly to the access point 3 described above. Hereinafter, in a case where any one of a plurality of configurations such as the terminals 2-1 to 2-N is not specified, the terminals are simply referred to as terminals 2 or the like.

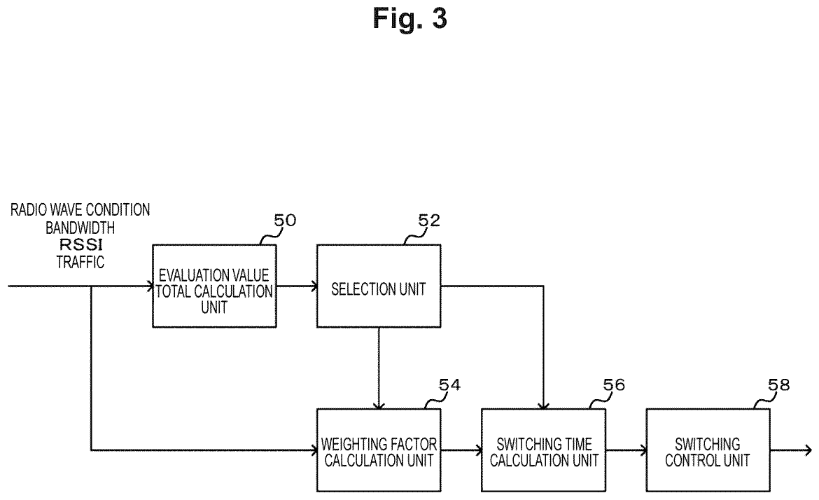

FIG. 3 is a functional block diagram illustrating functions of the control device 4. As illustrated in FIG. 3, the control device 4 includes, for example, an evaluation value total calculation unit 50, a selection unit 52, a weighting factor calculation unit 54, a switching time calculation unit 56, and a switching control unit 58.

The evaluation value total calculation unit 50 first acquires, for example, information on a condition of radio waves used for wireless communication between the terminals 2-1 to 2-N and the access point 3 in the wireless communication system 1, a bandwidth, a received signal strength indicator (RSSI), a traffic amount, and the like. Then, the evaluation value total calculation unit 50 calculates the transmission capacity of each channel as an evaluation value, calculates an evaluation value total of each combination of one or more channels whose frequency bands do not overlap each other, and outputs the calculation result to the selection unit 52.

The selection unit 52 selects a combination of a predetermined number (for example, two) of channels in which the evaluation value total calculated by the evaluation value total calculation unit 50 is maximum within a predetermined range (for example, 720 seconds), and outputs the selection result to the weighting factor calculation unit 54 and the switching time calculation unit 56.

The weighting factor calculation unit 54 first acquires, for example, information on a condition of radio waves used for wireless communication between the terminals 2-1 to 2-N and the access point 3 in the wireless communication system 1, a bandwidth, an RSSI, a traffic amount, and the like. Then, the weighting factor calculation unit 54 calculates a weighting factor indicating a proportion of a use period of each channel included in the combination selected by the selection unit 52, on the basis of the bandwidth, the transmission rate, the transmittable data amount, the RSSI, and the like of each channel, and outputs the calculated weighting factor to the switching time calculation unit 56.

The switching time calculation unit 56 calculates the switching time for switching a channel for each channel included in the combination selected by the selection unit 52 on the basis of the weighting factor calculated by the weighting factor calculation unit 54, and outputs the calculation result to the switching control unit 58.

The switching control unit 58 performs control such that the access point 3 (or the terminal 2) transmits traffic by switching the channel included in the combination selected by the selection unit 52 on the basis of each switching time calculated by the switching time calculation unit 56.

In addition, the switching control unit 58 performs switching control so that the access point 3 (or the terminal 2) repeats channel switching within a monitoring time (for example, 30 minutes) that is determined in advance to be a shorter period than the unit time (for example, 1 hour).

Note that each function of the control device 4 illustrated in FIG. 3 may be included in the access point 3.

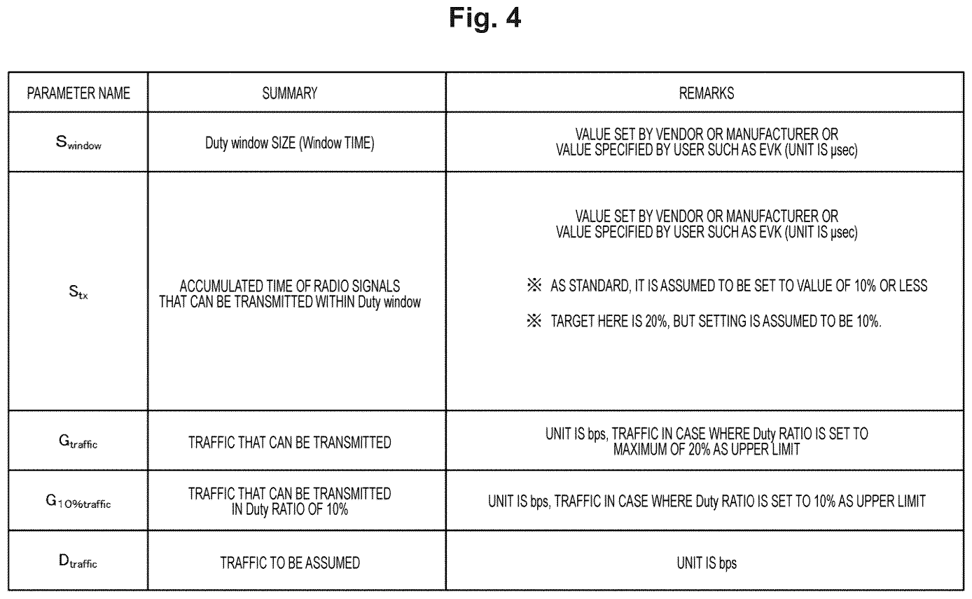

Next, an operation example of the wireless communication system 1 according to an embodiment will be described. First, parameters used in the operation example of the wireless communication system 1 will be described with reference to FIG. 4. As illustrated in FIG. 4, it is assumed that S_{window} is a Duty window size (Window time: μsec) set or specified by a vendor, a manufacturer, or the like.

It is assumed that Sₜₓ is an accumulated time (μsec) of radio signals that can be transmitted within a Duty window set or specified by a vendor, a manufacturer, or the like.

It is assumed that G_{traffic} is, for example, a total of traffic that can be transmitted by the terminal 2 per unit time, and is traffic (bps) in a case where a Duty ratio is set to a maximum of 20% per terminal (a sum of transmission times per hour is within 720 seconds) as an upper limit.

It is assumed that the G_{10% traffic} is, for example, traffic (bps) that can be transmitted by the terminal 2 per unit time, and is traffic in a case where a Duty ratio is 10% (a sum of transmission times per hour is within 360 seconds) as an upper limit.

It is assumed that the D_{traffic} is, for example, traffic (bps) that is assumed to be actually transmitted by the terminal 2.

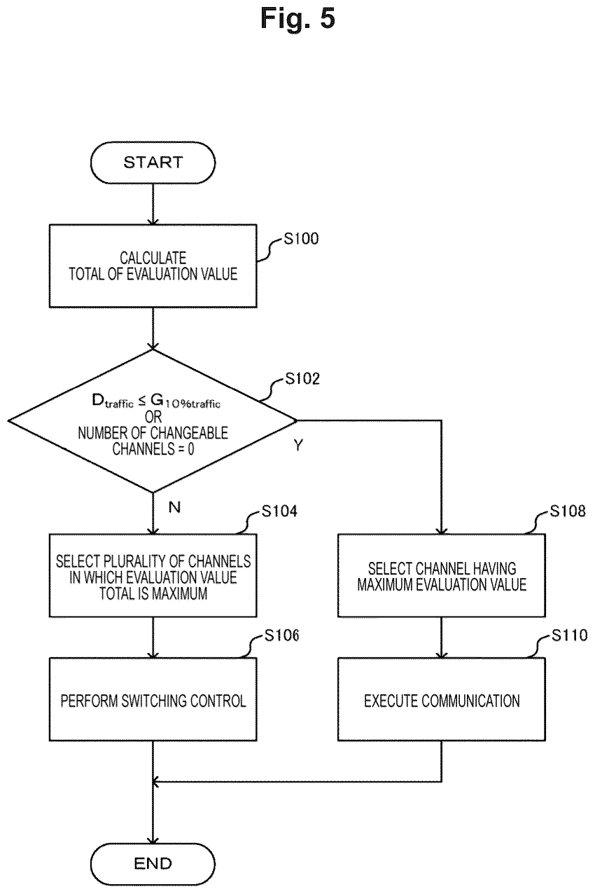

FIG. 5 is a flowchart illustrating an operation example of the wireless communication system 1 according to an embodiment.

In step 100 (S100), in the wireless communication system 1, the evaluation value total calculation unit 50 included in the control device 4 numerically evaluates a channel capacity for each selectable channel (transmission rate of all bandwidths). Then, on the premise that the terminal 2 and the access point 3 use a plurality of channels, the evaluation value total calculation unit 50 calculates a total of evaluation values of a plurality of combinable channels (here, two channels are assumed but not limited thereto).

Note that a plurality of channels can be combined only within a range in which occupied frequency bands (frequency bands used in the channels) do not overlap each other.

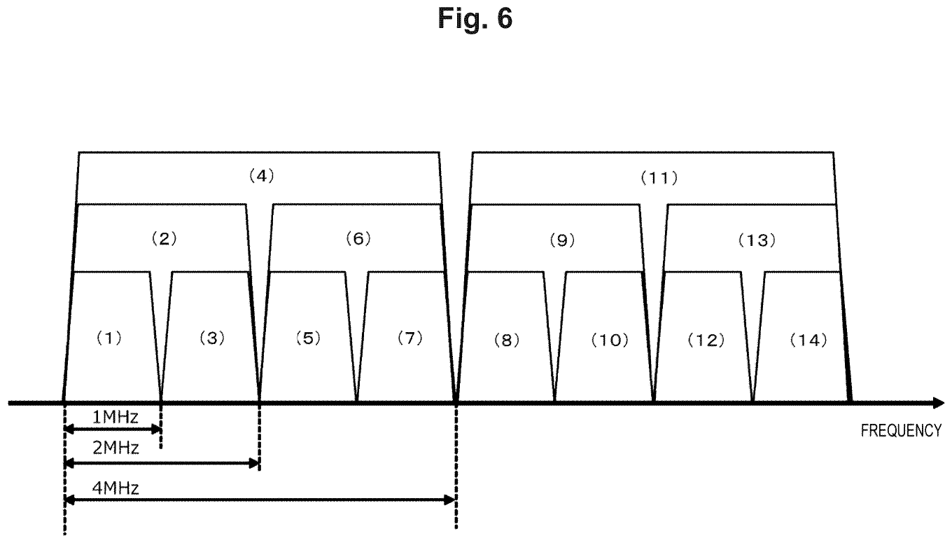

For example, in an example of the channel illustrated in FIG. 6, a channel that can be combined with a channel (1) of 1 MHz width (bandwidth) is a channel other than (2) and (4). In addition, channels that can be combined with (2) having a width of 2 MHz are channels other than (1), (3), and (4).

However, in a case where there is no other combinable channel in a selectable maximum channel bandwidth, the evaluation value in one channel is treated similarly to a total value instead of the total of evaluation values of combined channels.

In step 102 (S102), the selection unit 52 determines whether D_{traffic} (assumed transmission traffic) can be transmitted within a Duty ratio of 10% of a channel having a maximum evaluation value, or whether there is a changeable channel. That is, the selection unit 52 determines whether or not D_{traffic}≤G_{10% traffic} or the number of changeable channels=0, and proceeds to processing of S104 in the case of No, and proceeds to processing of S108 in the case of Yes. Note that, in a case where D_{traffic}≤G_{10% traffic} or the number of changeable channels=0, the selection unit 52 considers that there is no need to switch channels.

In step 104 (S104), the selection unit 52 selects a combination of a plurality of channels (two channels in the present embodiment) in which the evaluation value total is a maximum within a predetermined range (the sum of the transmission times per hour is within 720 seconds).

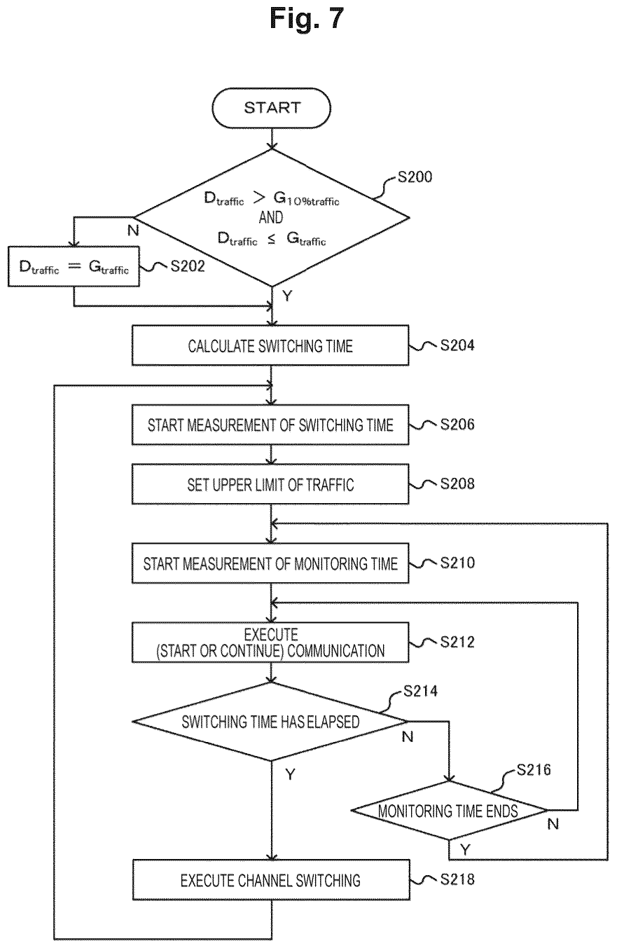

In step 106 (S106), the switching control unit 58 performs switching control to switch a plurality of channels on the basis of the switching time calculated by the switching time calculation unit 56 (see FIG. 7 to be described later).

In step 108 (S108), the selection unit 52 selects a channel having the maximum evaluation value.

In step 110 (S110), the switching control unit 58 executes communication using the channel selected by the selection unit 52 in the processing of S108.

FIG. 7 is a flowchart illustrating processing executed by the control device 4 for control to switch a plurality of channels.

In step 200 (S200), in a case where the traffic assumed to be transmitted exceeds the Duty ratio of 10% and does not exceed the Duty ratio of 208, the control device 4 determines to start calculation processing for the switching time. Specifically, the selection unit 52 determines whether or not D_{traffic}>G_{10% traffic} and D_{traffic}≤G_{traffic}, and proceeds to processing of S202 in the case of No, and proceeds to processing of S204 in the case of Yes.

In step 202 (S202), the selection unit 52 performs processing of regarding that D_{traffic}=G_{traffic}.

That is, in a case where the traffic assumed to be transmitted exceeds the Duty ratio of 208, the control device 4 does not perform calculation so as to transmit all the assumed traffic, but performs calculation with the traffic having the Duty ratio of 20% as an upper limit. Specifically, in a case where D_{traffic}>G_{traffic}, the traffic assumed to be transmitted is too large, and thus the selection unit 52 replaces the assumed traffic with the transmittable traffic.

In step 204 (S204), the control device 4 starts calculation of the switching time. In this case, the control device 4 sets, as the switching time, a time obtained by multiplying the window by the weighting factor described above for each channel, from the start of the window (monitoring time (S_{window}) for monitoring the sum of the transmission times: channel use period) for observing the Duty.

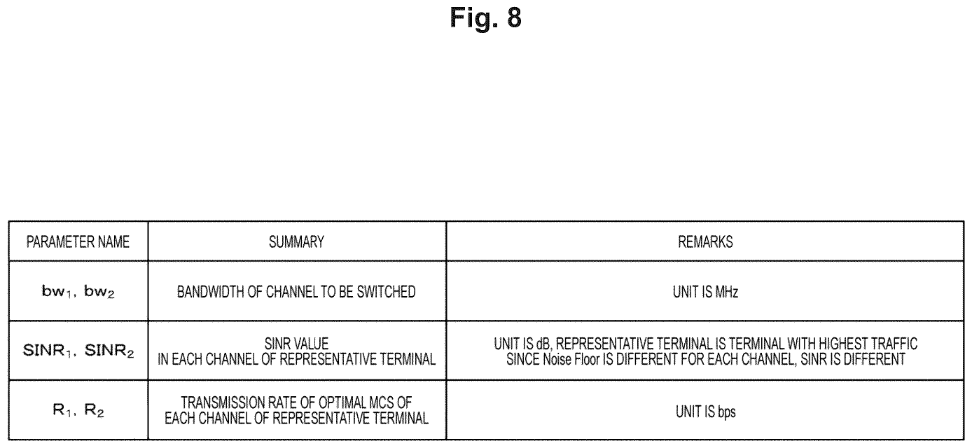

FIG. 8 is a diagram illustrating parameters regarding weighting factors w₁ and w₂ in a case where a control device 4 performs control to switch two channels. As illustrated in FIG. 8, bw₁ and bw₂ each indicate a bandwidth of a channel to be switched, SINR₁ and SINR₂ each indicate a signal to interference plus noise ratio (SINR) value in each channel of a representative terminal, and R₁ and R₂ each indicate a transmission rate of an optimal modulation and coding scheme (MCS) of each channel of the representative terminal.

Then, the weighting factor calculation unit 54 calculates the weighting factors w₁ and w₂ by the following Expressions (1) and (2), respectively.

$$\begin{matrix}[ Math . 1 ] & \\ {w}_{1} = \frac{{R}_{1}}{{R}_{1} + {R}_{2}} & ( 1 )\end{matrix}$$

$$\begin{matrix}[ Math . 2 ] & \\ {w}_{2} = \frac{{R}_{2}}{{R}_{1} + {R}_{1}} & ( 2 )\end{matrix}$$

Note that the weighting factors w₁ and w₂ may be calculated as a ratio of the amount of data that can be transmitted in the Duty ratio of 10% within a Window of the transmission rate, in addition to being calculated by the transmission rate of the optimum MCS.

In step 206 (S206: FIG. 7), the switching control unit 58 starts measurement of the switching time (switching fixed time: first timing 1 and second timing) calculated by the switching time calculation unit 56 using the following Expressions (3) and (4) for each of, for example, two channels selected by the selection unit 52.

$$\begin{matrix}[ Math . 3 ] & \\ Switching fixed time ( first timing ) = From start of first Duty window to {S}_{window} \times {w}_{1} & ( 3 )\end{matrix}$$

$$\begin{matrix}[ Math . 4 ] & \\ Switching fixed time ( second timing ) = From start of second Duty window to {S}_{window} \times {w}_{2} & ( 4 )\end{matrix}$$

In step 208 (S208), the control device 4 sets an upper limit (Duty ratio 10%) of traffic of each channel of each terminal 2. Specifically, the switching control unit 58 sets the upper limit of the traffic amount (byte) for each channel to the Duty ratio of 10% per hour and shortens each time when each channel is actually used, thereby finally setting the traffic transmitted by the terminal 2 using a plurality of channels to the transmission rate with the Duty ratio of 10% or more.

In step 210 (S210), the switching control unit 58 starts measurement of the monitoring time according to the upper limit of the traffic of each channel. The monitoring time (S_{window}) is a period of monitoring whether or not the limit of the Duty ratio of 10% is observed for each channel. That is, it is set to a period shorter than the unit time (1 hour) described above, which is 30 minutes here.

In step 212 (S212), the switching control unit 58 performs control to execute (start or continue) communication between the terminal 2 and the access point 3.

In step 214 (S214), the switching control unit 58 determines whether or not the switching time has elapsed for each channel, and proceeds to processing of S218 in a case where it is determined that the switching time has elapsed (S214: Yes), and proceeds to processing of S216 in a case where it is determined that the switching time has not elapsed (S214: No).

In step 216 (S216), the switching control unit 58 determines whether or not the monitoring time has elapsed, and returns to processing of S210 in a case where it is determined that the monitoring time has elapsed (S216: Yes), and returns to processing of S212 in a case where it is determined that the monitoring time has not elapsed (S216: No).

In step 218 (S218), the switching control unit 58 executes channel switching (channel transition) in which communication is being executed, and returns to the processing of S206.

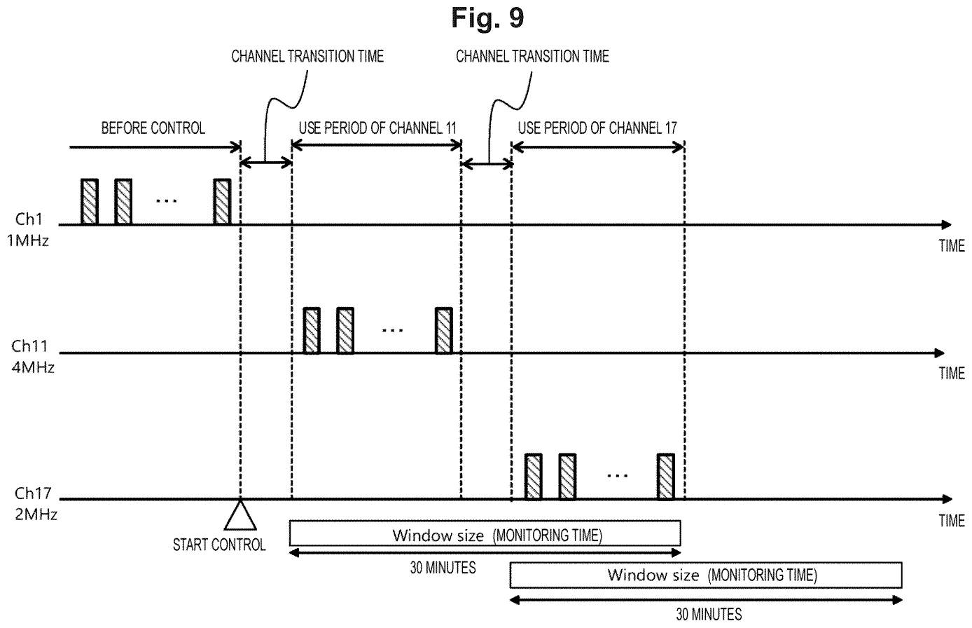

Next, a specific operation example of the wireless communication system 1 according to an embodiment will be described with reference to FIG. 9. FIG. 9 is a diagram illustrating a specific operation example of the wireless communication system 1 according to an embodiment.

First, in the wireless communication system 1, it is assumed that the terminal 2 and the access point 3 perform communication using Ch1 having a 1 MHz width before the control device 4 starts switching control.

Next, it is assumed that the control device 4 executes channel switching control and selects Ch11 having a width of 4 MHz and Ch17 having a width of 2 MHz as a combination of channels.

In this case, it is assumed that the transmission capacities of the channels are different from each other, the transmission rate of MCS7 of Ch17 is 6.5 Mbps, and the transmission rate of Ch11 is 13.5 Mbps.

In this case, since the weighting factor w1=0.325 and the weighting factor w2=0.675, a channel having a width of 4 MHz is used up to 20.25 minutes in 30 minutes of window, and a channel having a width of 2 MHz is used up to 9.75 minutes in 30 minutes of window.

Then, the switching control unit 58 repeats the switching of the channels until the time to start the next window size (monitoring time). Therefore, the wireless communication system 1 can realize transmission with the Duty ratio of 10% or more by using a plurality of channels while maintaining a constant transmission capacity, even when a sum of transmission times for transmitting traffic per unit time is limited for each channel. That is, in the wireless communication system 1, even when a sum of the transmission times for transmitting traffic per unit time is limited for each channel, a transmission capacity can be maximized within a predetermined range.

Some or all of the functions of the control device 4 may be configured with hardware such as a programmable logic device (PLD) or a field programmable gate array (FPGA) or may be configured as a program executed by a processor such as a CPU.

For example, the control device 4 according to the present invention can be implemented by using a computer and a program, and the program can be recorded in a storage medium or provided through a network.

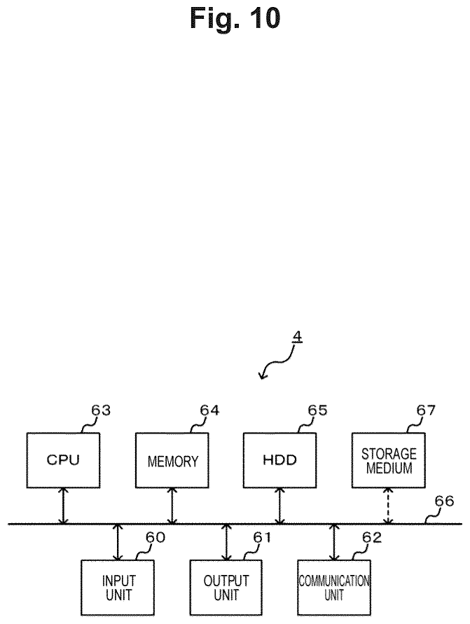

FIG. 10 is a diagram illustrating a hardware configuration example of the control device 4 according to an embodiment. As illustrated in FIG. 10, for example, the control device 4 has a function as a computer in which an input unit 60, an output unit 61, a communication unit 62, a CPU 63, a memory 64, and an HDD 65 are connected via a bus 66. The control device 4 can input and output data to and from a computer-readable storage medium 67.

The input unit 60 is, for example, a keyboard, a mouse, or the like. The output unit 61 is, for example, a display device such as a display. The communication unit 62 is, for example, a wired or wireless network interface.

The CPU 63 controls each unit included in the control device 4 and performs a predetermined process or the like. The memory 64 and the HDD 65 are storage devices that store data and the like. The storage medium 67 can store a program or the like executing a function of the control device 4. An architecture that configures the control device 4 is not limited to the example illustrated in FIG. 10.

Reference Signs List

| | |
|---|---|
| 1 | Wireless communication system |
| 2-1 to 2-N | Terminal |
| 3 | Access point |
| 4 | Control device |
| 30 | Memory |
| 31 | Drive |
| 32 | User interface |
| 33 | Wired communication module |
| 34-1, 34-2 | Wireless communication module |
| 35 | Timer |
| 36 | Control circuit |
| 37 | Bus |
| 60 | Input unit |
| 61 | Output unit |
| 62 | Communication unit |
| 63 | CPU |
| 64 | Memory |
| 65 | HDD |
| 66 | Bus |
| 67 | Storage medium |
| 300 | Control program |
| 302 | Management information |
| 310 | Storage medium |

1. A control device that controls a wireless communication system in which a sum of transmission times for transmitting traffic per unit time is limited for each channel and which performs wireless communication using at least one of a plurality of channels, the control device comprising:
evaluation value total calculation circuitry configured to calculate a transmission capacity of each channel as an evaluation value and calculates an evaluation value total of each combination of one or more channels whose frequency bands do not overlap each other;
selection circuitry configured to select a combination of a predetermined number of channels in which the evaluation value total calculated by the evaluation value total calculation circuitry is a maximum within a predetermined range;
weighting factor calculation circuitry configured to calculate a weighting factor indicating a proportion of a use period of each channel included in the combination selected by the selection circuitry, based on a transmission rate or a transmittable data amount of each channel;
switching time calculation circuitry configured to calculate a switching time for switching a channel for each channel included in the combination selected by the selection circuitry, based on the weighting factor calculated by the weighting factor calculation circuitry; and
switching control circuitry configured to perform control to switch a channel included in the combination selected by the selection circuitry and transmit traffic, based on each switching time calculated by the switching time calculation circuitry.

2. The control device according to claim 1,
wherein the switching control circuitry
performs control to repeat channel switching within a monitoring time that is determined in advance to be a shorter period than the unit time.

3. A wireless communication method in which a sum of transmission times for transmitting traffic per unit time is limited for each channel and which performs wireless communication using at least one of a plurality of channels, the wireless communication method comprising:
calculating a transmission capacity of each channel as an evaluation value and calculating an evaluation value total of each combination of one or more channels whose frequency bands do not overlap each other;
selecting a combination of a predetermined number of channels in which the calculated evaluation value total is a maximum within a predetermined range;
calculating a weighting factor indicating a proportion of a use period of each channel included in the selected combination, based on a transmission rate or a transmittable data amount of each channel;
calculating a switching time for switching a channel for each channel included in the selected combination, based on the calculated weighting factor; and
controlling to switch a channel included in the selected combination and transmit traffic, based on each calculated switching time.

4. The wireless communication method according to claim 3,
wherein in controlling,
control is performed to repeat channel switching within a monitoring time that is determined in advance to be a shorter period than the unit time.

5. A wireless communication system in which a sum of transmission times for transmitting traffic per unit time is limited for each channel and which performs wireless communication using at least one of a plurality of channels, the wireless communication system comprising:
an evaluation value total calculation circuitry configured to calculates a transmission capacity of each channel as an evaluation value and calculates an evaluation value total of each combination of one or more channels whose frequency bands do not overlap each other;
a selection circuitry configured to selects a combination of a predetermined number of channels in which the evaluation value total calculated by the evaluation value total calculation circuitry is a maximum within a predetermined range;
a weighting factor calculation circuitry configured to calculates a weighting factor indicating a proportion of a use period of each channel included in the combination selected by the selection circuitry, based on a transmission rate or a transmittable data amount of each channel;
a switching time calculation circuitry configured to calculates a switching time for switching a channel for each channel included in the combination selected by the selection circuitry, based on the weighting factor calculated by the weighting factor calculation circuitry; and
a switching control circuitry configured to performs control to switch a channel included in the combination selected by the selection circuitry and transmit traffic, based on each switching time calculated by the switching time calculation circuitry.

6. The wireless communication system according to claim 5,
wherein the switching control circuitry
performs control to repeat channel switching within a monitoring time that is determined in advance to be a shorter period than the unit time.

7. A non-transitory computer-readable storage medium storing a control program causing a computer to function as each circuitry of the control device according to claim 1.
